(19) United States
(12) Patent Application Publication
(10) Pub. No.: US 2024/0039204 A1
(43) Pub. Date: Feb. 1, 2024

(54) Waterproof USB Connection Device

(71) Applicant: Jasco Products Company, Oklahoma City, OK (US)

(72) Inventor: Rob Workman, Oklahoma City, OK (US)

(21) Appl. No.: 17/878,849

(22) Filed: Aug. 1, 2022

(51) Int. Cl. H01R 13/52; H01R 13/74; H01R 13/58

(52) U.S. Cl. CPC H01R 13/5202; H01R 13/746; H01R 13/5845

(57) ABSTRACT

The present invention pertains to devices which provide a connection, and in particular, a USB connection to a housing for an electrical device. More specifically, the invention pertains to a device or devices which provide a waterproof seal between a USB molded strain relief and a housing for an electrical device. The invention provides an efficient connection with minimal junction points. Embodiments described for the present invention comprise a housing, a USB connection, a gland nut, and a housing male threaded boss, wherein the housing male threaded boss is molded onto a rear housing. The device may comprise a USB connector and a flange extending from the USB molded strain relief, wherein the flange, gland nut, and housing male threaded boss are configured to form a waterproof seal.

### BACKGROUND OF THE INVENTION

### 1. Field of the Invention

The present invention pertains to devices which provide a connection, and in particular, a USB connection to a housing for an electrical device. More specifically, the invention pertains to a device or devices, which provide a waterproof seal between a USB cord and a housing for an electrical device.

### 2. Description of the Related Art

Waterproof connections are highly desirable for numerous settings, including exterior applications or interior applications where moisture is present, such as kitchens or bathrooms. In exterior applications, electrical devices may be exposed to rain, humidity, or other moisture. Electrical devices exposed to the elements are often at a risk for electrical failure.

Electrical connections, including waterproof connections, comprised of multiple junctions have an increased opportunity for failure. Known prior art disclose complex electrical connections which comprise metal isolating middle plates, first and second terminal groups, metal fasteners, metal inner shells, contact portions, soldering legs integrated with the contact portion, small prongs or plugs projecting from the connector, and multiple insulators.

U.S. Pat. No. 10,724,712 discloses modular lighting systems that comprise lighting strips physically and electrically connectable with one another by way of flexible connectors. The lighting strip devices can be made of flexible or rigid material to allow for applying the lighting devices along flat as well as contoured surfaces and can be waterproof or water resistant.

U.S. Pat. No. 11,081,834 discloses a waterproof USB socket including a connector, a metal housing, a waterproof glue filled in a tail portion of the connector, and a waterproof ring. The connector includes a metal intermediate plate, first and second terminal groups, and an insulating body. The insulating body includes a base portion, a step portion formed by extending forward from the base portion, and a docking portion formed by extending forward from the step portion.

### SUMMARY OF THE INVENTION

The present invention comprises a waterproof USB electrical connection between a USB molded strain relief and an electrical device. The invention provides an efficient connection with minimal junction points.

Embodiments described for the present invention comprise a housing, a USB connection, a gland nut, and a housing male threaded boss, wherein the housing male threaded boss is molded onto a rear housing. The device may comprise a USB connector and a flange extending from the USB molded strain relief, wherein the flange, gland nut, and housing male threaded boss are configured to form a waterproof seal.

It should be appreciated that combinations of the foregoing concepts and additional concepts discussed in greater detail below are contemplated as being part of the inventive subject matter disclosed herein. In particular, all combinations of claimed subject matter appearing at the end of this disclosure, or elsewhere herein, are contemplated as being part of the inventive subject matter.

These and other systems, methods, objects, features, and advantages of the present invention will be apparent to those skilled in the art from the following detailed description of the preferred embodiment and the drawings.

### BRIEF DESCRIPTION OF THE DRAWINGS

One or more embodiments are illustrated by way of example, and not by limitation, reference will now be made to the accompanying drawings, having the same numeral designations to represent like elements throughout and wherein:

FIG. 1 shows a front elevational view of an embodiment of a device;

FIG. 2 shows a perspective view of an embodiment of a device;

FIG. 3 shows a right side elevational view of an embodiment of a device;

FIG. 4 shows a rear elevational view of an embodiment of a device;

FIG. 5 shows a front elevational view of an embodiment of a device;

FIG. 6 shows a perspective view of an embodiment of a device;

FIG. 7 shows a left side elevational view of an embodiment of a device;

FIG. 8 shows a rear elevational view of an embodiment of a device;

FIG. 9 shows a front elevational view of an embodiment of a device;

FIG. 10 shows a perspective view of an embodiment of a device;

FIG. 11 shows a left side elevational view of an embodiment of a device;

FIG. 12 shows a rear elevational view of an embodiment of a device;

FIG. 13 shows a front elevational view of an embodiment of a device;

FIG. 14 shows a perspective view of an embodiment of a device;

FIG. 15 shows a right side elevational view of an embodiment of a device;

FIG. 16 shows a rear elevational view of an embodiment of a device; and

FIG. 17 shows a right side sectional view of an embodiment of a device.

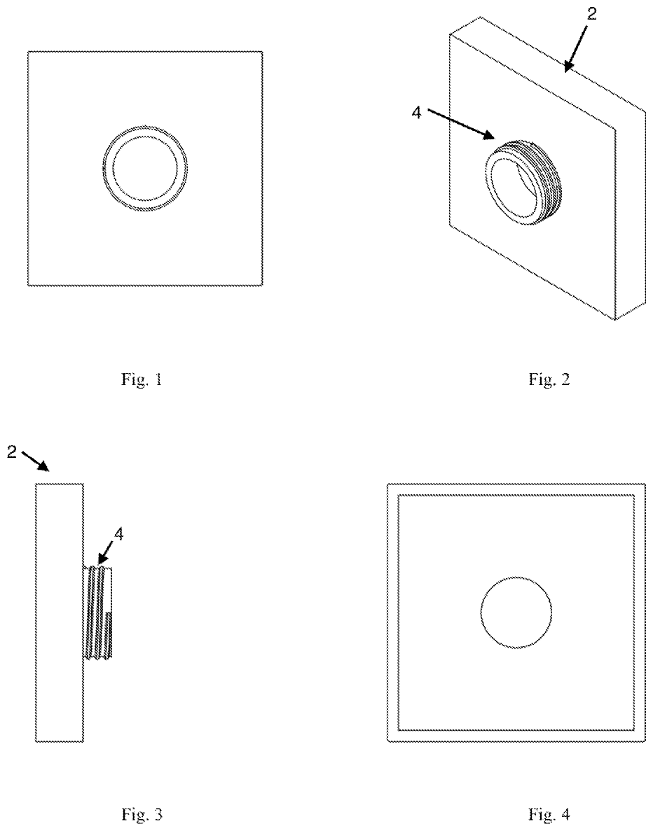

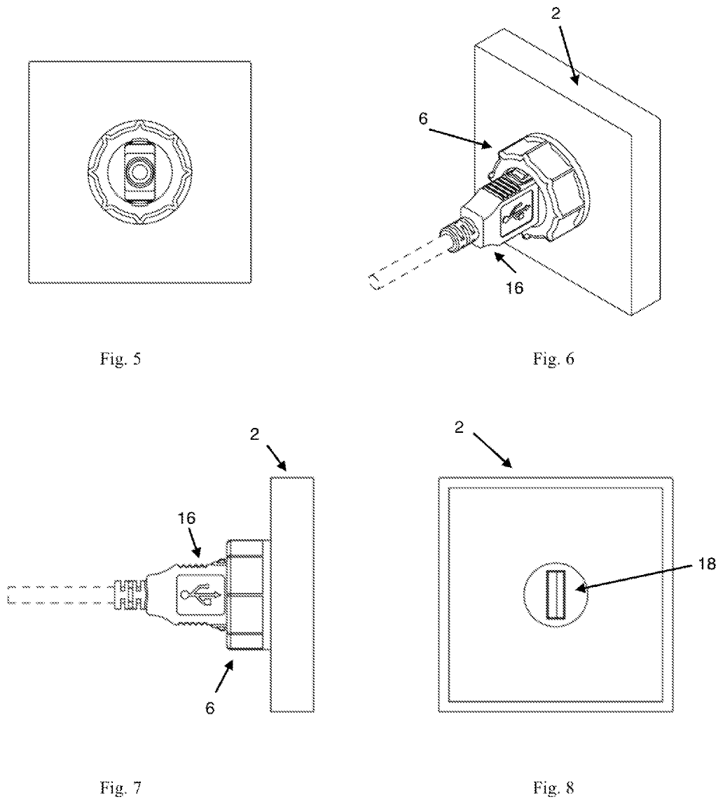

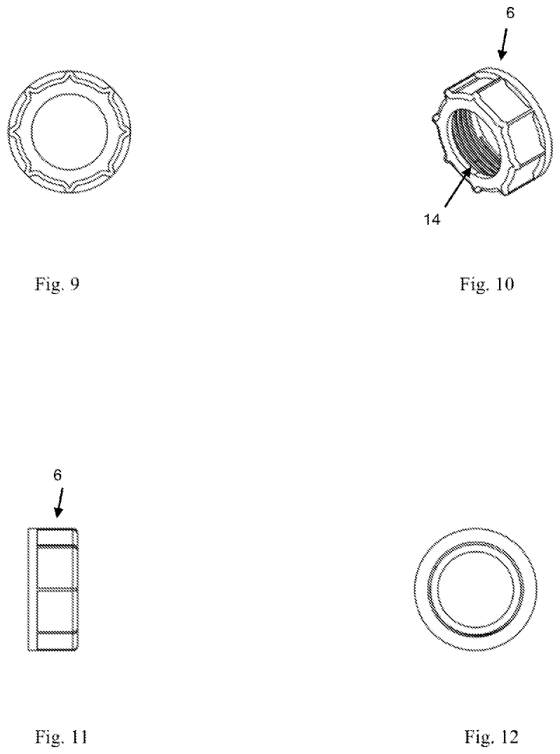

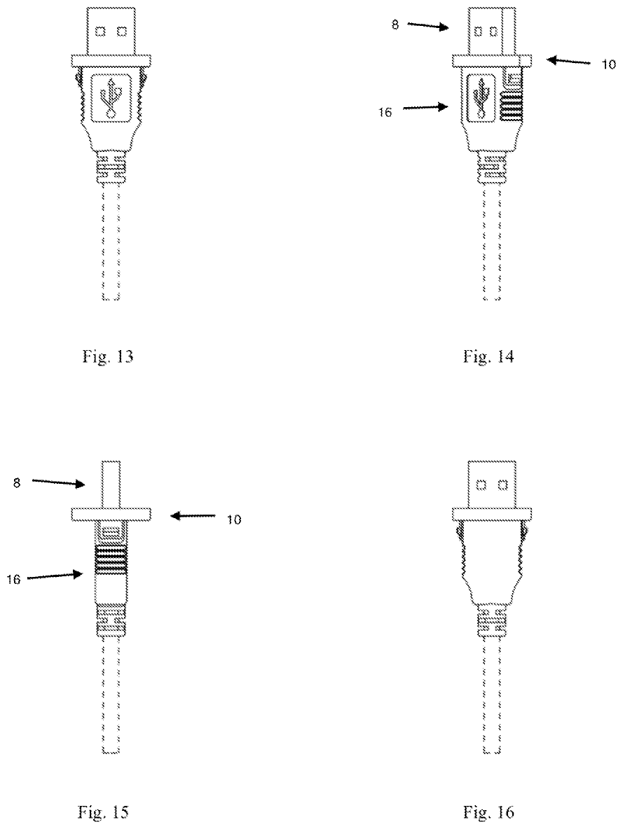

While the invention has been described in connection with certain preferred embodiments, other embodiments would be understood by one of ordinary skill in the art and are encompassed herein.

Elements with corresponding reference numerals:
Waterproof USB connection device 100
Housing 2
Housing male threaded boss 4
Gland nut 6
USB connector 8
Flange 10
Rear housing 12
Gland nut threading 14
p USB molded strain relief 16
USB connector 18

### DETAIL DESCRIPTION OF THE INVENTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in order to facilitate describing the subject innovation. Moreover, it is to be appreciated that the drawings may not be to scale.

FIG. 2 shows a perspective view of an embodiment of a waterproof USB connection device. The device may include a variety of components. In this embodiment, a housing male threaded boss 4 is molded to a housing 2 of an electrical device. The molded connection of the housing male threaded boss 4 to the housing 2 forms a waterproof seal between the two components of the waterproof USB connection device. The electrical device may be a lighting device, a sound device, or any exterior application or interior application where moisture is present. Interior applications include, but are not limited to, kitchen or bathroom devices. The housing 2 may vary in size and composition and is not limited by the size and dimension of the illustrations. The male threaded boss 4 may also vary in size and composition. The threading on the male threaded boss 4 may be a standard configuration or a reverse thread.

FIG. 3 shows a right side elevational view of a waterproof USB connection device. FIG. 3 illustrates another view of the molded connection between the housing male threaded boss 4 and the housing 2. In an alternate embodiment, the housing male threaded boss 4 and the housing 2 may be designed and constructed as a single component from a single mold. The size, dimensions, and relative size and dimensions of the housing male threaded boss 4 and the housing 2 are not limited by FIG. 3 or by any other illustration of this disclosure.

FIG. 6 shows a perspective view of an embodiment of a waterproof USB connection device. FIG. 6 illustrates a USB molded strain relief 16 connected with a waterproof seal to a housing 2 of an electrical device. A gland nut 6 tightens the USB molded strain relief 16 to the housing 2. The gland nut 6 forms a simple junction with a flange 10 (not shown). The simple connection of the gland nut 6 and the flange 10 provides a waterproof seal, while the limited junction points minimizes the opportunity for failure. The gland nut 6 may attach by a clockwise or a reverse clockwise motion.

FIG. 7 shows a left side elevational view of an embodiment of a waterproof USB connection device. The relative size and dimensions of the components may not be to scale. A gland nut 6, a housing male threaded boss 4 (not shown), a USB molded strain relief 16, a flange 10 (not shown), and a housing 2 form a waterproof seal for a USB connection. The gland nut 6 connects to the flange 10 of the USB molded strain relief 16 and creates a waterproof seal with the housing 2 when it is rotated onto the housing male threaded boss 4 (not shown).

FIG. 8 shows a rear elevational view of an embodiment of a waterproof USB connection device. FIG. 8 illustrates the entrance of a USB male connector end 18 into a housing. A USB connector is placed within a housing male threaded boss of the device.

FIG. 10 shows a perspective view of an embodiment of a waterproof USB connection device. FIG. 10 illustrates a gland nut 6. The gland nut threading 14 may be in a standard or reverse thread configuration. The relative size and dimension of the thread is not limited by the illustrations of this disclosure. In this embodiment, the gland nut 6 is comprised of exterior bevels and ridges for easier and tighter rotation. The current embodiment also illustrates an exterior lip that abuts up to a housing (not shown). An aperture of the gland nut 6 provides an opening for a USB cord and a USB connector to pass through, while a flange (not shown) connects to the gland nut 6 to form a waterproof seal.

FIG. 11 shows a left side elevational view of an embodiment of a waterproof USB connection device. The flat adjoining surface of the gland nut 6 provides a waterproof seal with the housing of an electrical device.

FIG. 14 shows a perspective view of an embodiment of a waterproof USB connection device. A USB connector 8 extends from a USB molded strain relief 16. A flange 10 extends outwardly from the USB molded strain relief 16. The flange 10 creates a waterproof seal with the gland nut 6 (not shown), when the gland nut is tightened onto a housing male threaded boss of a housing.

FIG. 15 shows a right side elevational view of an embodiment of a waterproof USB connection device. FIG. 15 illustrates an alternate view of the USB molded strain relief 16, the USB connector 8, and the flange 10. The relative size and dimensions of the flange 10 are not limited by this illustration. In this embodiment, the flange 10 is a circular extension from the USB molded strain relief 16. The flange 10 creates a uniform waterproof seal when pulled tightly against the housing male threaded boss by the rotation of the gland nut onto the housing male threaded boss. The flange 10 is held within the aperture of the gland nut.

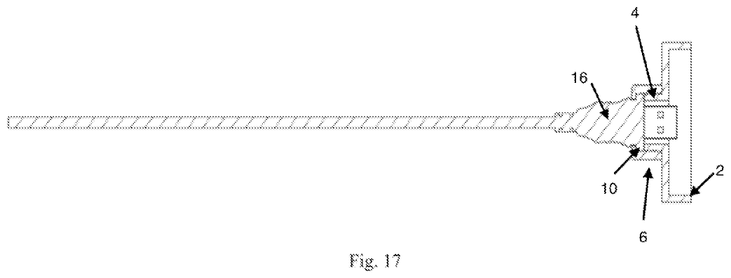

FIG. 17 shows a right side sectional view of an embodiment of a waterproof USB connection device. A housing male threaded boss 4 is molded to a housing 2 of an electrical device. The molded connection of the housing male threaded boss 4 to the housing 2 forms a waterproof seal between the two components of the waterproof USB connection device. The electrical device may be any exterior application or interior application where moisture is present. A gland nut 6 connects to a flange 10 of a USB molded strain relief 16 and creates a waterproof seal with the housing 2 when it is rotated onto the housing male threaded boss 4.

In an embodiment of the device, the flange 10 and the USB molded strain relief 16 are composed of the same compressible material. Both the flange 10 and the USB molded strain relief 16 are formed from the same mold. The gland nut 6 is configured to accommodate the flange 10. The flange 10 and USB molded strain relief 16 are tightened onto the housing male threaded boss.

Although the present invention has been described in relation to particular embodiments thereof, many other variations and modifications will become apparent to those skilled in the art. It is preferred, therefore, that the present invention be limited not by the specific disclosure herein, but only by the appended claims. Alternate embodiments may be devised without departing from the spirit or scope of the invention. Further, the particular feature or structure may be combined in any suitable manner in one or more embodiments.

What is claimed is:

1. A waterproof usb device, comprising: vv a housing of an electrical device;
a USB connector;
a gland nut;
a housing male thread boss, wherein the housing male thread boss is molded onto the housing;
a USB molded strain relief;
a flange;
the gland nut is configured to accommodate the flange; and
the gland nut tightens the flange onto the male thread boss to form a waterproof seal between an inside of the housing and an outside of the housing.

2. The waterproof usb device of claim 1, further comprising:
the flange is comprised of a compressible material.

3. The waterproof usb devices claim 1, further comprising:
the USB molded strain relief and the flange are molded from the same compressible material.

4. A waterproof usb device, comprising:
a USB cord;
a USB molded strain relief;
a USB connector; and
a flange, wherein the flange is configured to form a waterproof seal between an inside of a housing and an outside of a housing.

5. erproof usb device of claim 4, further comprising:
the flange is comprised of a compressible material.

6. The waterproof usb devices claim 4, further comprising:
the USB molded strain relief and the flange are molded from the same compressible material.

8. A waterproof usb device, comprising:
a housing of an electrical device;
a USB connector;
a USB molded strain relief;
a gland nut;
a housing male thread boss, wherein the housing male thread boss is molded onto the housing;
a flange; and
the gland nut, the housing male thread boss, the USB molded strain relief, and the flange are configured to form a waterproof seal between an inside of the housing and an outside of the housing.

9. The waterproof usb device of claim 6, further comprising:
the flange is comprised of a compressible material.

10. The waterproof usb device of claim 6, further comprising:
the gland nut is configured to accommodate the flange; and
the flange tightens onto the housing male thread boss.

11. The waterproof usb device of claim 6, further comprising:
the USB molded strain relief and the flange are molded from the same compressible material.
